(19) United States
(12) Patent Application Publication
(10) Pub. No.: US 2023/0342875 A1
(43) Pub. Date: Oct. 26, 2023

(54) TRANSPORTATION LOGISTICS SYSTEMS AND METHODS

(71) Applicant: Vorto Technologies, LLC, Denver, CO (US)

(72) Inventors: Priyesh RANJAN, Denver, CO (US); Samuel Robert MCLAUGHLIN, Denver, CO (US)

(73) Assignee: Vorto Technologies, LLC, Denver, CO (US)

(21) Appl. No.: 18/301,779

(22) Filed: Apr. 17, 2023

Related U.S. Application Data
(60) Provisional application No. 63/333,026, filed on Apr. 20, 2022.

(51) Int. Cl. G06Q 50/30; G06F 9/455; G06Q 10/02

(52) U.S. Cl. CPC G06Q 50/30; G06F 9/455; G06Q 10/02

(57) ABSTRACT

Disclosed systems and methods relate to generating an optimized simulated tour. In some embodiments, a system can include a display device; a memory; and a processor coupled to the memory programmed with executable instructions including: a data collector to receive a transportation load data and a market data; a user interface to collect a user input, the user input including a user profile, a transportation tour parameter, and a current information of the user; a data filter to filter the transportation load data and the market data based on the user input; a network model engine to generate a network model based on the filtered transportation load data and the filtered market data; a simulation engine to: simulate the transportation tour based on the network model, and automatically select a simulated tour based on a simulated factor; and the user interface to display the selected simulated tour.

### CROSS-REFERENCE TO RELATED APPLICATIONS

This application claims priority to U.S. Provisional Application No. 63/333,026, filed on Apr. 20, 2022, titled “Transportation Logistics Systems and Methods,” which is incorporated herein by reference.

### TECHNICAL FIELD

Embodiments relate to transportation systems and methods.

### BACKGROUND

Modern day commerce can involve a complex supply chain with logistics of transporting a high number of goods from various locations. Carriers transporting goods often consider relevant data on the goods transported from various locations and often optimize the logistics of transporting goods based on certain preferences. Typically, carriers planning transportation of goods face a high number of options to choose from, which can include all of the goods to be delivered in one or more locations at a given time, and the carriers may rely upon certain assumptions or oversimplifications in considering options and plan an inefficient and unoptimized transportations of the goods. It can be a challenge to determine a highly efficient and optimized transportations of goods that can satisfy the carrier's preferences. For example, it can be difficult to collect information on the vast number of available goods to be transported in an entire country or other large geographic area and conduct an extensive analysis to optimize which goods to deliver and which routes to take, and even more difficult to do so taking into consideration other factors such as a carrier's preferences.

Logistics systems and methods can automatically collect data on a high number of goods to be transported, and can generate data-driven optimized transportations of goods based on the carrier's preferences. According to aspects of embodiments, a system for a transportation tour, the system comprising: a display device; a memory; and a processor coupled to the memory programmed with executable instructions, the instructions including: a data collector for automatically collecting data for the transportation tour, wherein the data collector is configured to receive a transportation load data and a market data; a user interface configured to collect a user input, the user input comprising a user profile, a transportation tour parameter, and a current information of the user; a data filter configured to filter the transportation load data and the market data based on the user input; a network model engine configured to generate a network model based on the filtered transportation load data and the filtered market data, wherein the network model comprises a network of transportation loads; a simulation engine configured to: simulate the transportation tour based on the network model, and automatically select a predetermined number of simulated tours based on a simulated factor; and the user interface further configured to display the selected predetermined number of the simulated tour.

In some embodiments, the user profile comprises at least one of an overhead cost, a commodity type criterion, a broker criterion, a customer criterion, a region criterion, a weather criterion, a terrain criterion, a certification criterion, or a credential criterion.

In some embodiments, the transportation tour parameter comprises a start date of the transportation tour, a start location of the transportation tour, and/or transport information.

In some embodiments, the transportation tour parameter further comprises an end date of the transportation tour, and an end location of the transportation tour.

In some embodiments, the current information of the user comprises at least one of a current location of the user or a current hour of service by the user operating a transport.

In some embodiments, the network model engine is configured to update the network model based on: a new transportation tour data collected by the data collector; a new market data collected by the data collector; or a new user input collected by the user interface.

In some embodiments, the network model comprises a probability model for the simulated tour.

In some embodiments, the simulated factor comprises at least one of a revenue of the simulated tour, an earning of the simulated tour, or an earning over distance traveled in the simulated tour.

In some embodiments, the transportation tour comprises a series of one or more transportation loads.

In some embodiments, the user interface is further configured to: display the selected predetermined number of the simulated tours for an approval by the user; receive an approval input from the user; book a first transportation load in an approved simulated tour; and display a booked status of the first transportation load in approved simulated tour.

According to aspects of embodiments, a method for a transportation tour, the method comprising: automatically collecting a transportation load data and a market data; collecting, via a user interface, a user input, the user input comprising a user profile, a transportation tour parameter, and a current information of the user; filtering the transportation load data and the market data based on the user input; generating a network model based on the filtered transportation load data and the filtered market data, wherein the network model comprises a network of transportation loads; simulating the transportation tour based on the network model; automatically selecting a predetermined number of simulated tour based on a simulated factor; and displaying, via the user interface, the selected predetermined number of the simulated tour.

In some embodiments, the user profile comprises at least one of an overhead cost, a commodity type criterion, a broker criterion, a customer criterion, a region criterion, a weather criterion, a terrain criterion, a certification criterion, or a credential criterion.

In some embodiments, the transportation tour parameter comprises a start date of the transportation tour, a start location of the transportation tour, a transport information.

In some embodiments, the transportation tour parameter further comprises an end date of the transportation tour, and an end location of the transportation tour.

In some embodiments, the current information of the user comprises at least one of a current location of the user or a current hour of service by the user operating a transport.

In some embodiments, the method further comprises updating the network model based on: a new transportation tour data collected by the data collector; a new market data collected by the data collector; or a new user input collected by the user interface.

In some embodiments, the network model comprises a probability model for the simulated tour.

In some embodiments, the simulated factor comprises at least one of a revenue of the simulated tour, an earning of the simulated tour, or an earning over distance traveled in the simulated tour.

In some embodiments, the transportation tour comprises a series of one or more transportation loads.

In some embodiments, the method further comprises: displaying, via the user interface, the predetermined number of the selected simulated tours for an approval by the user; receiving, via the user interface, an approval input from the user; booking, via the user interface, a first transportation load in an approved simulated tour; and displaying, via the user interface, a booked status of the first transportation load in the approved simulated tour.

### BRIEF DESCRIPTION OF THE DRAWINGS

FIG. 1 shows an exemplary logistics process for generating an optimized tour of transportation loads and routes according to an exemplary embodiment.

FIG. 2 shows an exemplary user interface screenshot before a tour of transportation loads and routes is booked according to an exemplary embodiment.

FIGS. 3-4 show exemplary user interface screenshots of booked tour of transportation loads and routes according to exemplary embodiments.

FIGS. 5-7 show exemplary user interface screenshots of a user input module according to exemplary embodiments.

FIGS. 8-10 show exemplary user interface screenshots of a data collection module and/or a simulation module according to exemplary embodiments.

FIGS. 11-14 show exemplary user interface screenshots of a module for simulated tours of transportation loads and routes according to exemplary embodiments.

FIG. 15 shows an exemplary user interface screenshot of “Tours Submitted” according to an exemplary embodiment.

FIG. 16 shows an exemplary user interface screenshot of “Booking in Progress” according to an exemplary embodiment.

FIGS. 17A-17D show exemplary user interface screenshots of a tour of transportation loads and routes according to exemplary embodiments.

FIGS. 18-21 show exemplary user interface screenshots of a tour of transportation loads and routes according to exemplary embodiments.

FIG. 22 shows an exemplary user interface screenshot of a user input module according to an exemplary embodiment.

FIGS. 23-24 show exemplary user interface screenshots of a booking module according to exemplary embodiments.

While embodiments of the disclosure are amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

According to some exemplary embodiments, systems and methods disclosed herein may simulate and optimize transportation of goods or loads and transportation routes based on collected data and user inputs from a carrier or a transport driver. In some embodiments, the data can be automatically collected and filtered based on the user inputs to generate a network model, which can be continually or periodically updated with any new data collected or any new user input. In some embodiments, the network model can be used to run simulations on tours of transporting certain loads in certain routes. In some embodiments, the systems and methods described herein can select one or more simulated tours of transportation loads and routes, for example, based on the user's selection or approval. In some embodiments, the systems and methods described herein can book or confirm the selected or approved tours, or one or more loads and routes associated with the selected or approved tours.

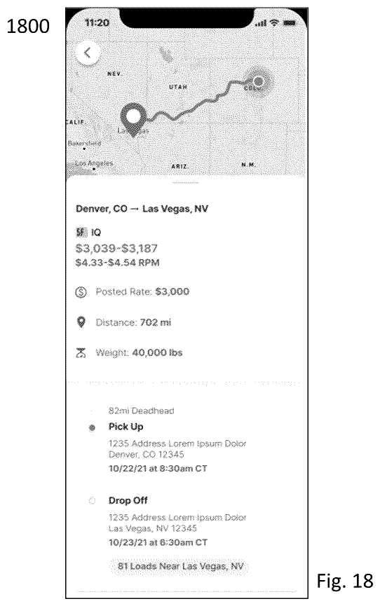

The term “goods” or “loads” described herein, for example, can be anything that may be transported by transports such as trucks, trailers, vans, rails, ships, aircrafts, or any other vehicles. The term “carrier” described herein, for example, can be a person or an entity that transports goods or loads. The term “driver” described herein, for example, can be a person, a system, or an entity that directly or indirectly operates the transports. The term “tour” described herein, for example, can be a single transportation or a series of transportations of loads (e.g., a tour can include transportations of one or more loads in a series such as Load 1, Load 2, Load 3, Load 4, Load 5, Load 6, Load 7, etc. as illustrated in FIGS. 17A-17D) by a carrier or a driver. The term “optimized” described herein, for example, in optimized tours does not necessarily refer to the absolute best, and instead, can represent tours that can satisfy certain factors or preferences, for example, better or higher earnings than other tours.

The systems and methods described herein, for example, can create value for users by automatically collecting data on transportation of goods or loads and transportation routes and filtering the collected data based on the user inputs, which can avoid the need for the user to manually collect or evaluate the data. In another example, the systems and methods described herein can also create value for users by generating a network model based on the filtered data to run simulation of transportation tours. In another example, the systems and methods described herein can also create value for users by automatically selecting simulated tours based on simulated factors such as earnings. In another example, the systems and methods described herein can also create value for users by better utilizing the data on current and historical data on transportation of goods or loads and transportation routes and/or current and historical market data. In another example, the systems and methods described herein can also create value for users by generating a data-driven optimized tour that can increase or maximize users' earnings. In another example, the systems and methods described herein can also create value for users by providing a highly efficient and optimized tour (e.g., keeping the tour busy with less down time or less empty loads) by minimizing inconsistency and unpredictability in the tour, which can be done, for example, by bundling several shipments in the right markets over a tour. In another example, the systems and methods described herein can also create value for users by allowing the users to charge less compensation per load in a tour (e.g., by lowering a premium in compensation based on uncertainty), while increasing the overall earnings in the tour based on a highly efficient and optimized tour provided by the systems and methods. These and other advantages are described further herein.

The systems and methods described here, for example, can also create value for the shippers, brokers, and customers of the goods or loads that are transported by the users. For example, the systems and methods described herein can also create value for the shippers, brokers, and customers by providing enhanced coverage of the transportation of the goods or loads. In another example, the systems and methods described herein can also create value for the shippers, brokers, and customers by reducing the costs of the transportation. The costs can be reduced, for example, based the systems and methods described herein automatically collecting and better utilizing the data on current and historical data on transportation of goods or loads and transportation routes and/or current and historical market data, which can allow the supply to meet the demand (and vice versa) more efficiently. The costs can also be reduced, for example, based the systems and methods described herein minimizing inconsistency and unpredictability in the tour of transportation and allowing the users (e.g., carriers or drivers of the transport) to charge less compensation per load by lowering a premium based on uncertainty. For example, carriers or drivers can charge a premium on uncertainty in their usual compensation rate for transportation of goods or loads, which can increase the shipping costs for the shippers, brokers, and customers. The systems and methods described herein can provide value by reducing such uncertainty premiums. These and other advantages are described further herein.

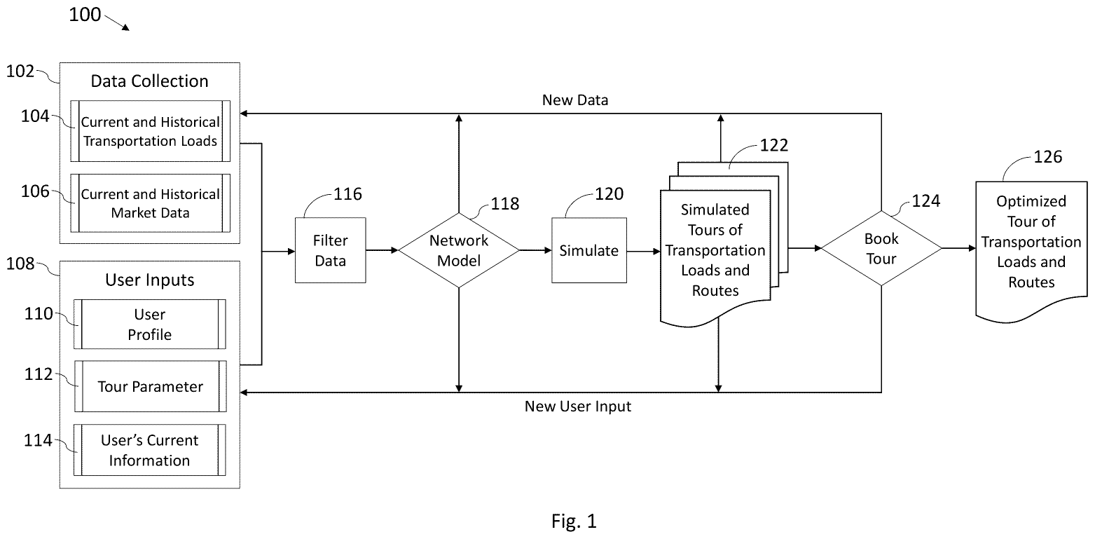

FIG. 1 shows an exemplary logistics process 100 for generating an optimized tour of transportation loads and routes according to an exemplary embodiment. In some embodiments, the logistics process 100, for example, can include a data collection step 102 and a user inputs step 108, which can be the inputs to the process 100, and an optimized tour of transportation loads and routes 126 can be the output of the process 100.

In some embodiments, the data collection 102 can collect data on current and historical transportation loads 104 and current and historical market data 106. In some embodiments the data collection 102 can collect data on current and historical transportation loads 104 in certain regions (e.g., city, state, province, country, or continent). For example, the data collection 102 can collect data on current and historical loads 104 that are currently available or were previously available for transportation in North America, United States, Canada, certain states, certain provinces, certain regions, certain cities, and/or the like.

In some embodiments, the data collection 102 can collect current and historical market data 106 that may relate to current and historical goods or loads 104 in certain regions (e.g., city, state, country, or continent). For example, the data collection 102 can collect data on current and historical market data 106 of loads that are or were available in North America, United States, Canada, certain states, certain provinces, certain regions, certain cities, and/or the like. In some embodiments, the data collection 102 can collect or compute current and historical aggregated market data on pricing and volume of goods or loads to be transported. For example, aggregated market data on pricing and volume of goods or loads can be collected or computed on a per lane basis from the origin to the destination of the shipment of goods or loads (e.g., origin-destination or origin-destination-trailer tuple). In some embodiments, the data collection 102 can collect or analyze weather data in certain regions (e.g., city, state, country, or continent) that can be relevant to transportation of goods or loads.

In some embodiments, the data collection 102 can collect data from first party sources (e.g., a party implementing the systems and methods described herein, or other parties that may have access to the systems and methods, for example, through software-as-a-service (SaaS) product offerings by the party implementing the systems and methods). In some embodiments, the data collection 102 can collect data from third party sources (e.g., parties that may provide data on current and historical goods or loads for transport in certain regions, which can include freight brokers, load boards, load posting services, shippers, integration with transportation management systems (TMS), or any other third parties). In some embodiments, the data collection 102 can collect data from various sources including first party sources and third party sources, and build aggregated pools of goods or loads for transportation. In some embodiments, the data collection 102 can perform natural language processing (NLP) to interpret the text data when collecting and interpreting data such as the current and historical loads data 104 and the current and historical market data 106.

In some embodiments, the data collection 102 can provide value by automatically collecting the current and historical data on transportation of goods or loads, and the current and historical market data from various sources, which can, for example, better utilize all available data related to the transportations. For example, the value can be created for the users by automatically collecting data from all available data related to the transportations from various sources. In another example, the value can be created for the various sources including shippers, brokers, and customers (e.g., parties that may provide data on current and historical goods or loads for transport and/or data on current and historical market data) by providing enhanced coverage of the transportation of the goods or loads, and also by reducing the costs of the transportation.

In some embodiments, user inputs 108 can collect inputs from a user (e.g., a carrier or a driver) relating to transportation of goods or loads such as a user profile 110, tour parameters 112, and user's current information 114. In some embodiments, the transport profile 110 (e.g., a profile of a carrier or a driver) can include transport operation costs (e.g., overhead cost per mile), certain preferences or criteria on commodity type, broker, customer, region, weather, terrain, certification, or credential. In some embodiments, one or more aspects of the transport profile 110 can be collected from the user once, and may not need to collect again, unless, for example, the user provides new inputs.

In some embodiments, the operation costs can be overhead costs for operating a transport such as loan payments (e.g., if the transport was purchased on a loan), insurance fees, license and registration fees, permit fees, fuel costs, transport maintenance costs, and any other expenses. In some embodiments, the operation costs can be averaged over a distance or a period of time. For example, averaged operation costs can include overhead cost per mile, cost per kilometer, and cost per day.

In some embodiments, the commodity type criterion can relate to preferences or requirements on certain types of good or loads, for example, based on ethical preferences, religious preferences, personal preferences, or equipment requirements. For example, transportation of pork or certain types of meat may not be preferred due to religious reasons. In another example, transportation of loads that must remain frozen or stored in cold temperature during the transportation may not be preferred if the transport lacks proper refrigeration systems that can meet certain temperature requirements.

In some embodiments, the broker criterion can relate to preferences on certain brokers that broker the shipment of loads or goods based on reputation, prior experience, or any other reasons. For example, transportation of loads brokered by certain brokers with good or bad reputations may be preferred or not preferred. In another example, a transportation of loads brokered by certain brokers may be preferred or not preferred based on prior experiences with such brokers.

In some embodiments, the customer criterion can relate to preferences on certain customers based on reputation, prior experience, or any other reasons. For example, certain customers may be preferred or not preferred based on reputations or prior experiences. For example, certain customers with difficult or inflexible appointment times for loading or unloading the loads may not be preferred.

In some embodiments, the regions criterion can relate to preferences on certain regions such as cities, states, countries, or continents based on traffic, permit requirements, laws and regulations, or any other reasons. For example, certain cities such as New York, Los Angeles, or Washington D.C. with reputations for having bad traffic congestion may not be preferred in some instances. In another example, certain states or countries may not be preferred for requiring permit(s) to transport goods or certain undesirable laws and regulations.

In some embodiments, the weather criterion can relate to preferences on certain weather conditions based on safety, equipment requirements such as snow chains for tires on snowy/icy roads, or any other reasons. For example, transportation of goods in bad weather such as operating a transport when snowing can pose a safety risk and may not be preferred. In another example, bad weather may not be preferred due to certain equipment requirements such as snow chains for tires when operating a transport in snowy or icy road conditions.

In some embodiments, the terrain criterion can relate to preferences on certain terrain based on safety, personal preferences, or any other reasons. For example, transportation of goods through mountainous terrains may not be preferred due to difficulty in operating a transport in curvy or steep mountain roads, risks, etc.

In some embodiments, the certification criterion can relate to a requirement for transporting certain goods or loads. For example, a commercial driver's license may be needed to operate commercial vehicles or transports. In another example, a hazardous material (“HAZMAT”) endorsement certification may be needed for a qualification to transport hazardous materials.

In some embodiments, the credential criterion can relate to a requirement for accessing certain regions, areas, buildings, facilities, etc. For example, a transportation worker identification credential (“TWIC”) card may be needed to access to ports, docks, vessels, ships, or similar locations or environments in United States. Such a credential may be needed or preferred in order to load or unload goods at ports, docks, vessels, ships, or similar locations or environments.

In some embodiments, the user inputs 108 can include tour parameter 112 for a tour of transporting loads, which can include a start location of the tour, an end location of the tour, a start date and time of the tour, an end date and time of the tour, transport information (e.g., type, size, length, and maximum payload weight of the transport such as truck, van, trailer, and/or the like), and any other information related to the tour. In some embodiments, a tour can be when a carrier or a driver delivers, for example, a series of one or more transportations of loads (e.g., a tour can include transportations of one or more loads in a series such as Load 1, Load 2, Load 3, Load 4, Load 5, Load 6, Load 7, etc. as illustrated in FIGS. 17A-17D) that can start and end on certain dates and times at certain locations.

In some embodiments, the start date and the end date of the tour can indicate when a carrier or a driver can start and end the tour of transporting loads. In some embodiments, the start and end dates and also times on those dates can be collected. The start date and the end date of the tour can be the same (e.g., the tour can start and end on the same day), or can be one or more days apart (e.g., the tour can span two or more days).

In some embodiments, the starting location and the ending location of the tour can indicate locations where a carrier or a driver can start and end the tour of transporting loads. In some embodiments, the starting and ending locations can be a city, county, town, district, borough, GPS coordinate, geofenced area, or any geographic location. For example, the starting location of the tour can be a city where the first load of the tour can be picked up for transporting, or the first load can be picked up within a predetermined threshold distance from the starting location (e.g., a predetermined threshold distance away from the city). In another example, the end location of the tour can be a city where the last load of the tour can be unloaded, or the last load can be unloaded within a predetermined threshold distance from the ending location (e.g., a predetermined threshold distance away from the city). The start location and the end location, for example, can be the same location or different locations such that the tour can start and end at the same location or at different locations.

In some embodiments, the transport information can indicate a type, size, length, and maximum payload weight of the transport for the tour such as truck, van, trailer, or any vehicle for the tour of transporting goods. For example, the transport information can indicate the amount or the size of loads that can be transported at a given time.

In some embodiments, the user inputs 108 can include a user's current information 114 such as a current location of the user (e.g., GPS data), current location of the user's transport (e.g., GPS data), current hours of service by a carrier or a driver (e.g., the user's current hours of service) operating the transport. In some embodiments, the user's current information 114 can be manually updated or automatically updated, for example, via a user interface.

In some embodiments, the logistics process 100 of FIG. 1 can include a filter data step 116, which can receive data from the data collection 102 and the user inputs 108, and filter the collected data based on the user inputs. For example, the filter data 116 can receive an aggregated pool of loads from the data collection 102 and filter the data based on the user inputs 108 for preferable or qualified options of goods or loads for transportation.

For example, the transport profile 110 of the user inputs 108 can be used to filter the data from the data collection 102. The commodity criterion of the transport profile 110, for example, can be used to filter certain types of commodities (e.g., filter pork freight due to religious reasons). In another example, the broker criterion can be used to filter certain brokers (e.g., filter certain brokers with bad reputations). The customer criterion of the transport profile 110, for example, can be used to filter out the goods or loads for certain customers (e.g., filter the loads associated with customers with bad reputation). The region criterion of the transport profile 110, for example, can be used to filter certain regions such as cities, states, provinces, countries, or continents (e.g., filter transportations of loads where the transportation routes may involve certain cities with heavy traffic congestion, filter certain states that may require special permits, filter certain countries or continents based on where the user prefers to operate the transport, and/or similar filters). The weather criterion of the transport profile 110, for example, can be used to filter out certain weather conditions (e.g., filter out transportations of certain loads where the transportation routes may experience a high chance of snow, or filter other unpreferred weather conditions). The terrain criterion of the transport profile 110, for example, can be used to filter certain terrains (e.g., filter transportations of certain loads where the transportation routes involve mountain roads). The certification criterion of the transport profile 110, for example, can be used to filter certain goods or loads (e.g., filter transportations of hazardous materials based on a certification status). The credential criterion of the transport profile 110, for example, can be used to filter certain regions, areas, buildings, facilities, etc. (e.g., filter transportations of certain loads where the transportation routes require access to areas such as ports based on a credential status).

In another example, the tour parameter 112 of the user inputs 108 can be used to filter the data from the data collection 102. The start date and the end date of the tour parameter 112, for example, can be used to filter transportation of loads that are not within the start and end dates/times. The start location and the end location of the transport parameter 112, for example, can be used to filter transportation of loads based on locations.

In another example, the user's current information 114 of the user inputs 108 can be used to filter the data from the data collection 102. The current location of the current information 114, for example, can be used to filter transportation of loads based on the current location of the transport. The current hours of service information of the current information 114, for example, can be used to filter the loads based on the calculated or estimated duration for transporting the loads, and also based on hours of service rules and regulations. In certain regions (e.g., country, state, province, and/or other geographic area), a carrier or a driver operating the transport may be required to comply with hours of service rules and regulations on the maximum amount of time permitted on duty such as driving time. The current hours of service information of the current information 114, for example, can be used to filter transportation of loads that can cause violation of hours of service rules and regulations.

In some embodiments, the filter data step 116 can involve natural language processing (NLP) to interpret the text data and to determine whether certain data can be qualified or unqualified for filtering. In some embodiments, the data filtering 116 can provide preferable or qualified options for transportation of goods and routes that can satisfy the user profile 110, tour parameter 112, or user's current information 114. In some embodiments, the data filtering step 116 can be performed when new data is collected by the data collection 102, or a user input in the user inputs 108 is changed or newly provided. In some embodiments, the data filtering 116 can be performed continually, periodically, or triggered by certain events such as detections of new data or a new user input.

In some embodiments, the logistics process 100 of FIG. 1 can include a network model generating step 118 for generating a network model of options for transportation based on the filtered data from the filter data step 116. In some embodiments, the logistics process 100 can generate a custom network model for each user (e.g., each carrier, each driver, and/or the like) based on the user inputs 108. For example, the network model 118 can be generated based on the data from the data collection 102 (e.g., current and historical transportation loads 104 and current and historical market data 106), which has been filtered based on the user inputs 108 (e.g., user profile 110, tour parameter 112, and user's current information 114). In some embodiments, the network model 118 can be generated with each node connecting to another node. For example, each node and its connection in the network model 118 can represent one or more options for transportation of loads and the route. For example, the network model 118 can represent the network of loads and routes in the United States (or other regions such as any continents, countries, states, provinces, cities, or regions based on the user inputs 108 on the regional preferences such as the region criterion of the transport profile 110) based on the filtered data from the filter data step 116. In some embodiments, the network model 118 can be generated based on a scale on the volume of loads.

In some embodiments, the network model 118 can be generated to be stochastic. When the desired tour or a later portion of the tour is several days or weeks out into the future, for example, the data that can be collected by the data collection 102 on transportation of loads on those future dates can be limited, and more data can become available later when the tour or a later portion of the tour becomes closer to the present. For example, the network model 118 can be continually or periodically updated with any new data collected from the data collection 102 or with any new user input from the user inputs 108. In some embodiments, the network model 118 can be used as a probability model to compute and predict a tour of transporting loads, routes, and earnings. The network model 118 can be a probability model, for example, based on an initial set of options or a later updated set of options, that can be used to compute and predict the transportation earnings. For example, the network model 118 can be used as a probability model, where the initial set of options from the data filter 116 can be used to compute probability weighted to maximize the transportation earnings for a carrier or a driver in a given tour.

In some embodiments, the logistics process 100 of FIG. 1 can include a simulate step 120 that can simulate one or more tours based on the network model 118. For example, the simulation 120 can simulate one or more tours based on a potential set of next loads according to the network model 118. In some embodiments, the simulation 120 can take many parameters into account, such as estimated durations for each segment of the journey, likelihood of delays, availability of suitable loads at the destination, distribution of pay for suitable loads at the destination, and many more.

In some embodiments, the logistics process 100 of FIG. 1 can include a step 122 of automatically selecting one or more simulated tours of transportation loads and routes based on one or more simulated factors. In some embodiments, the step 122 of automatically selecting a predetermined number of simulated tours can be selecting one or more simulated tours based on simulated factors such as expected earnings of the simulated tours. For example, the step 122 can include selecting a predetermined number of simulated tours with the highest expected earnings over the duration of the tours (e.g., dollars per day), the highest expected earnings over the distance of the tours (e.g., dollars per mile), the highest revenue, the highest above market rate loads, lowest deadhead (e.g., simulated tours with the least distance traveled with empty loads), any other simulated factors, or combinations thereof. In some embodiments, the one or more simulated tours can be selected and ranked based on the simulated factors. For example, the selected simulated tours can be ranked based on the expected earnings on the simulated tours.

In some embodiments, the selected simulated tours 122 can be presented to the user for approval. In some embodiments, the user can be requested to approve one simulated tour, or requested to approve more than one simulated tour, for example, to increase the chance of booking the selected simulated tours and to minimize any future back-and-forth. For example, some loads (e.g., with desirable features such as higher earnings) can be taken more quickly by other carriers or other drivers after becoming available to the industry or to the public (e.g., when a transportation request is published, posted online, or otherwise becomes available). Some selected tours or user approved tours, for example, can include such popular loads that can be taken by others before the loads can be booked for the user, and it can be advantageous in some instances to request the user to approve more than one simulated tour as a backup in case some of the selected or approved tours cannot be booked. In some embodiments, the user may not approve the selected tours, and the logistics process 100 can return to the data collection step 102 or the user inputs step 108 to rerun the process based on new data or a new user input.

In some embodiments, the logistics process 100 of FIG. 1 can include a book tour step 124 to reserve, book, or confirm the selected or approved simulated tours from the step 122. For example, the book tour step 124 can book at least a first load in the selected or approved simulated tours. When booking the tours, for example, the book tour step 124 can negotiate a higher payment rate for the user. In some embodiments, the book tour step 124 can try to book at least a first load in the selected or approved simulated tours with a priority on the tour that can generate higher earnings.

In some embodiments, when the book tour step 124 may not reserve, book, or confirm any load in the selected or approved simulated tours, the logistics process 100 can return to the data collection step 102 or the user inputs step 108. For example, the logistics process 100 can be performed again based on any new data from the data collection 102 or a new user input from the user inputs 108 until the process can successfully reserve, book, or confirm at least a first load in the selected or approved simulated tours.

In some embodiments, the logistics process 100 of FIG. 1, for example, can include an optimized tour output step 126 based on the successful result of the book tour step 124. When the book tour step 124 can successfully reserve, book, or confirm at least a first load in one of the selected or approved simulated tours, the tour with at least the first load booked, for example, can be notified to the user as the optimized tour output 126. The logistics process 100 of FIG. 1, for example, can be configured to control the transportation of the goods or loads based on the optimized tour output step 126 to provide value to the users.

In some embodiments, the logistics process 100 can provide value to the users by generating a data-driven optimized tour that can increase or maximize the users' earnings. In some embodiments, the logistics process 100 can also provide value to the shippers, brokers, and customers (e.g., parties that may provide data on current and historical goods or loads for transport and/or data on current and historical market data) by providing enhanced coverage, and also by reducing costs of the transportation.

### EXAMPLES

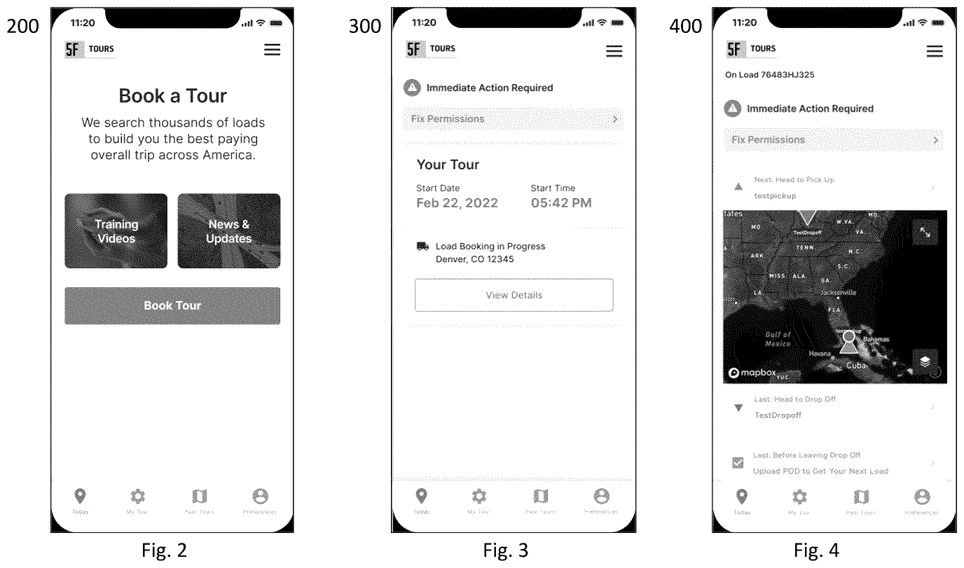

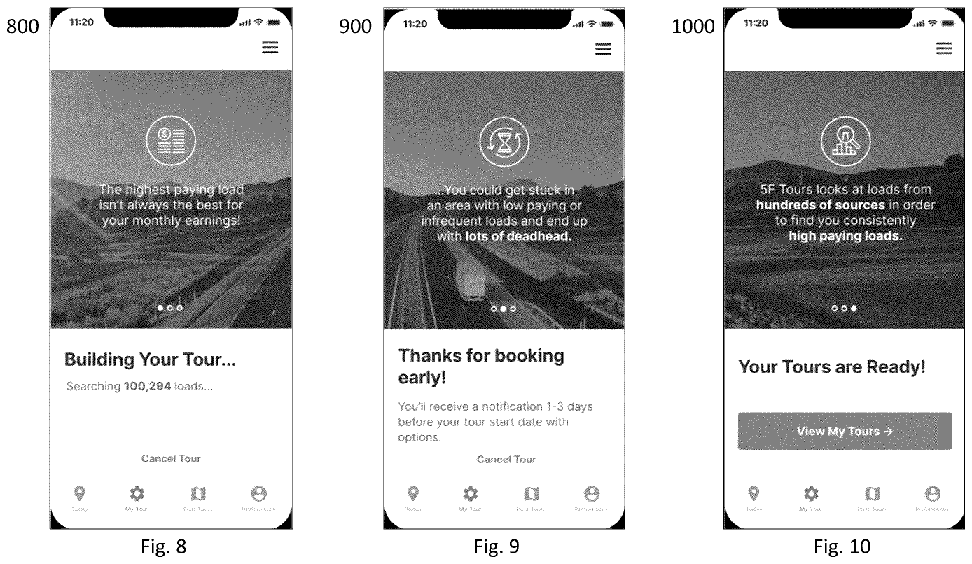

In some embodiments, one or more aspects of the exemplary logistics process 100 and the systems and methods described herein can be implemented in user interfaces as illustrated in FIGS. 2-24.

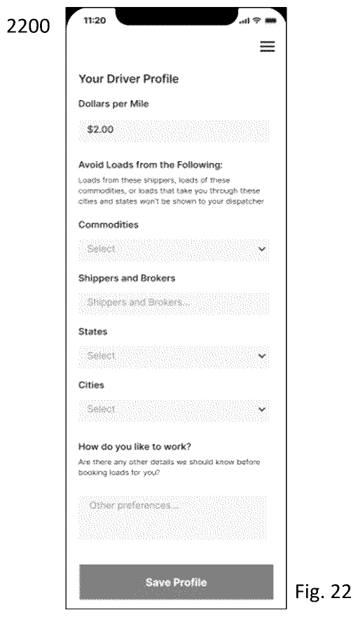

In some embodiments, the user profile 110 can be collected via user interface, for example, as illustrated in FIG. 22's user interface 2200 showing an exemplary driver profile for collecting operation costs (“Dollars per Mile”), certain preferences or criteria (“Commodities,” “Shippers and Brokers,” “States,” “Cities,” “Other preferences”), and other preferences (“How do you like to work?”).

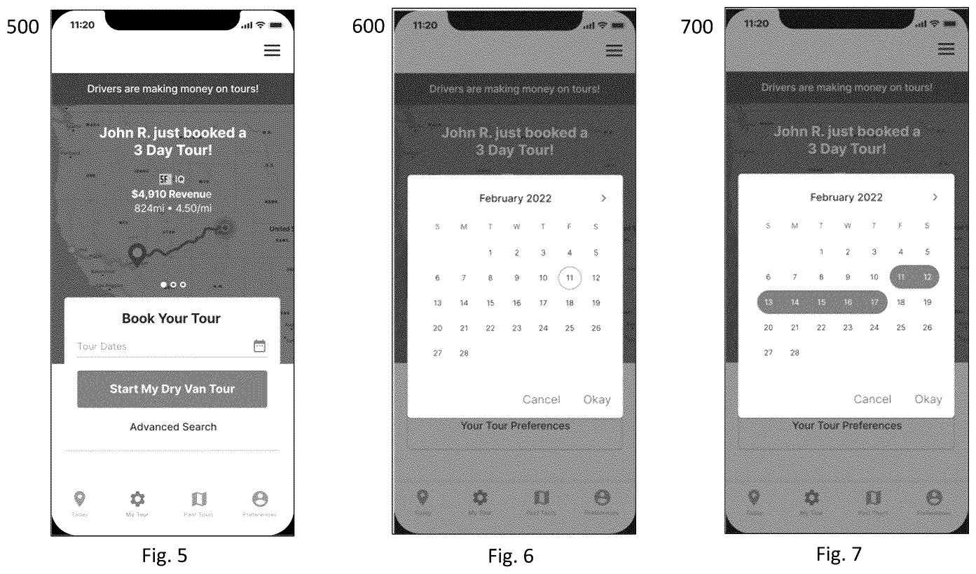

In some embodiments, the tour parameter 112 can be collected via user interface as illustrated in FIGS. 2 and 5-7 showing user interfaces 200, 500, 600, and 700 with exemplary input modules for starting and collecting the tour dates including the start date of the tour and the end date of the tour. FIG. 2, for example, illustrates an input module to start “Book Tour.” FIG. 3, for example, illustrates an input module to “Start My Dry Van Tour.” FIGS. 6 and 7, for example, illustrate input modules for collecting the tour dates including the start date of the tour and the end date of the tour. In some embodiments, a booked tour can be displayed via user interface as illustrated in FIGS. 3 and 4, showing a status of the booked tour and the action required for the booked tour.

In some embodiments, the user's current information 114 such as the current location of the user or the transport (e.g., GPS data) can be collected and displayed via user interface, for example, as illustrated in FIG. 14, showing a user interface 1400 collection and displaying an exemplary current location as somewhere in the middle of Colorado, United States.

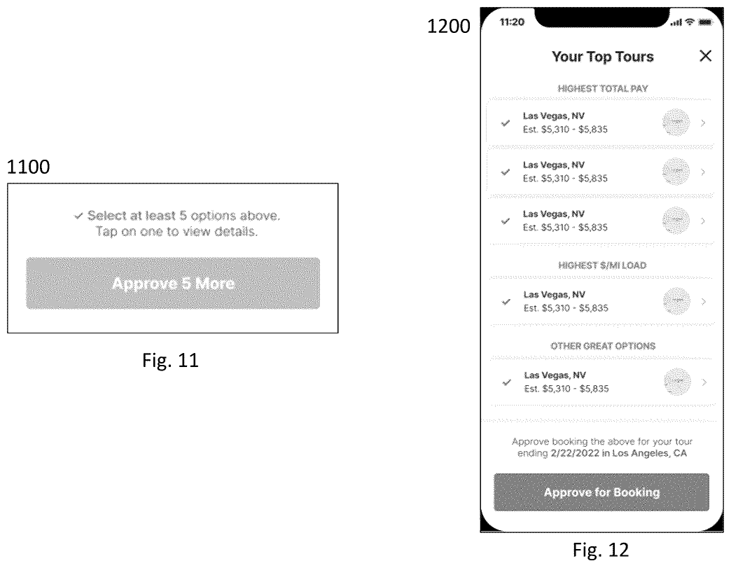

In some embodiments, the number of data on the transportation loads collected by the data collection step 102 can be indicated via user interface, for example, as illustrated in FIG. 8, showing a user interface 800 displaying “Searching 100,294 loads. . . ,” that can indirectly indicate the number of data collected as 100,294 data on the transportation loads. FIG. 8's user interface 800 can also indirectly indicate, for example, that logistic process 100's filter data 116, network model step 118, simulate step 120, and step 122 for selecting the simulated tours are being computed.

In some embodiments, when the tour parameter 112's start date of the tour, or a later portion of the tour is several days or weeks out into the future, for example, the data that can be collected by the data collection 102 on transportation of loads on those future dates can be limited, and more data can become available later when the tour or a later portion of the tour becomes closer to the present. FIG. 9, for example, illustrates an exemplary user interface 900 for indicating such limited data on the future dates' loads by indicating that the start date of the tour is too far into the future (e.g., by stating “Thanks for booking early! You'll receive a notification 1-3 days before your tour start date with options.”). FIG. 10, for example, illustrates an exemplary user interface 1000 for indicating that more data became available and the simulated tours are selected and ready for the user's view.

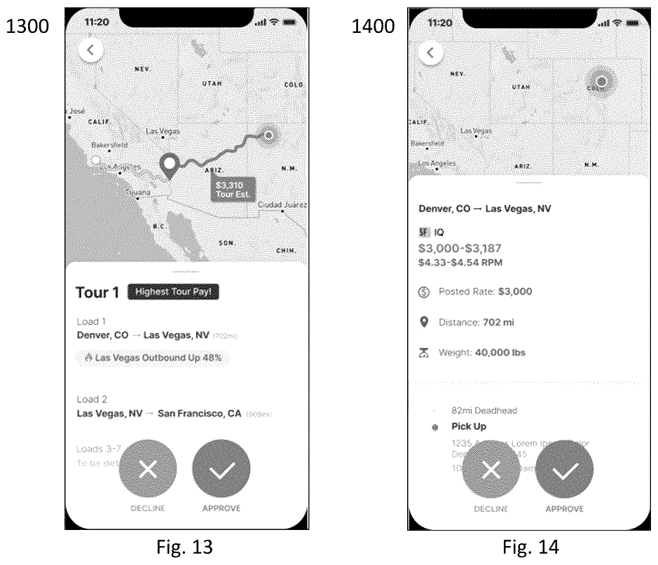

In some embodiments, the selected simulated tours from the logistics process 100's step 122 can be presented to the user for approval via user interface, for example, as illustrated in FIGS. 11-14. FIG. 11, for example, illustrates an exemplary user interface 1100 displaying a request to approve five or more simulated tours to the user, for example, to increase the chance of booking the selected simulated tours and to minimize any future back-and-forth. FIG. 12, for example illustrates an exemplary user interface 1200 displaying simulated tours that are selected based on “Highest Total Pay,” “Highest $/Mi Load,” and “Other Great Options” that are presented to the user to “Approve for Booking.” FIG. 13, for example, illustrates an exemplary user interface 1300 displaying Tour 1 as the selected simulated tour for approval, where Tour 1 comprises Load 1 (Denver, CO to Las Vegas, NV), Load 2 (Las Vegas, NV to San Francisco, CA), and Loads 3-7 (To be determined). FIG. 14, for example, illustrates an exemplary user interface 1400 displaying more information related to Load 1, which is from Denver, Co to Las Vegas, NV with an estimated payment of $3,000-3,187 and revenue per mile (RPM) of $4.33-$4.54 for the transportation weight of 40,000 lbs and distance of 702 mile. FIG. 14, for example, also illustrates that while the posted rate for this load is shown as $3,000, the logistics system 100 can be configured to negotiate a better rate such as up to $3,187 for the user.

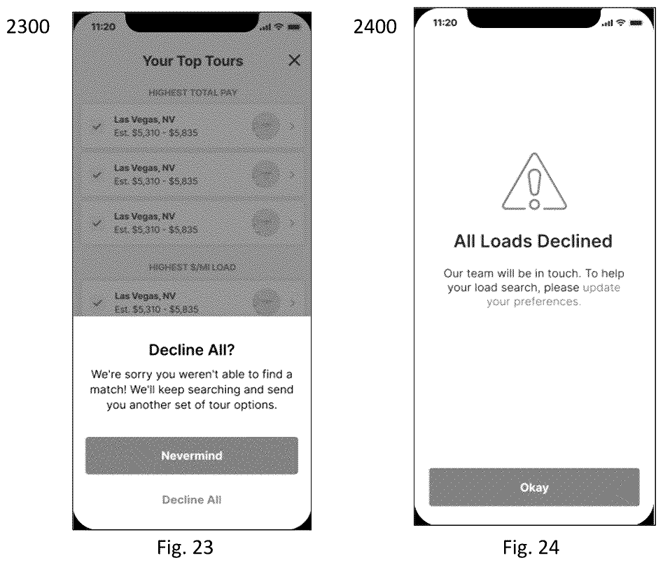

In some embodiments, the user may not approve the selected tour, for example, as illustrated in FIGS. 23 and 24. FIG. 23, for example, illustrates a user interface 2300 displaying an option to “Decline All.” FIG. 24, for example, illustrates a user interface 2400 displaying “All Loads Declined.”

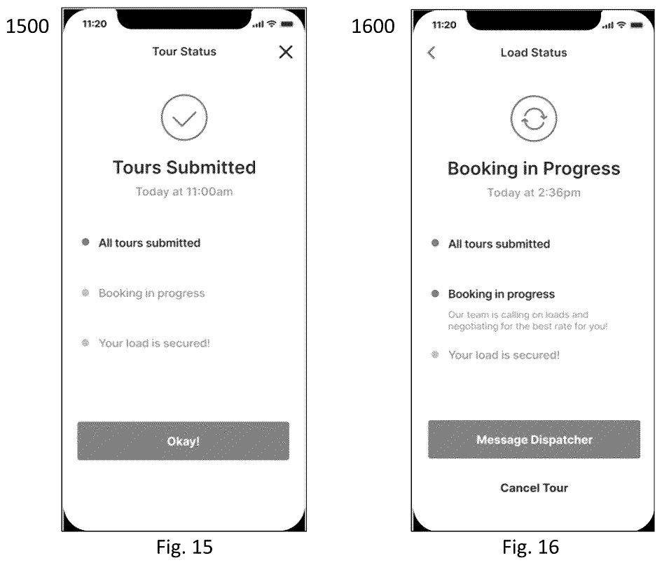

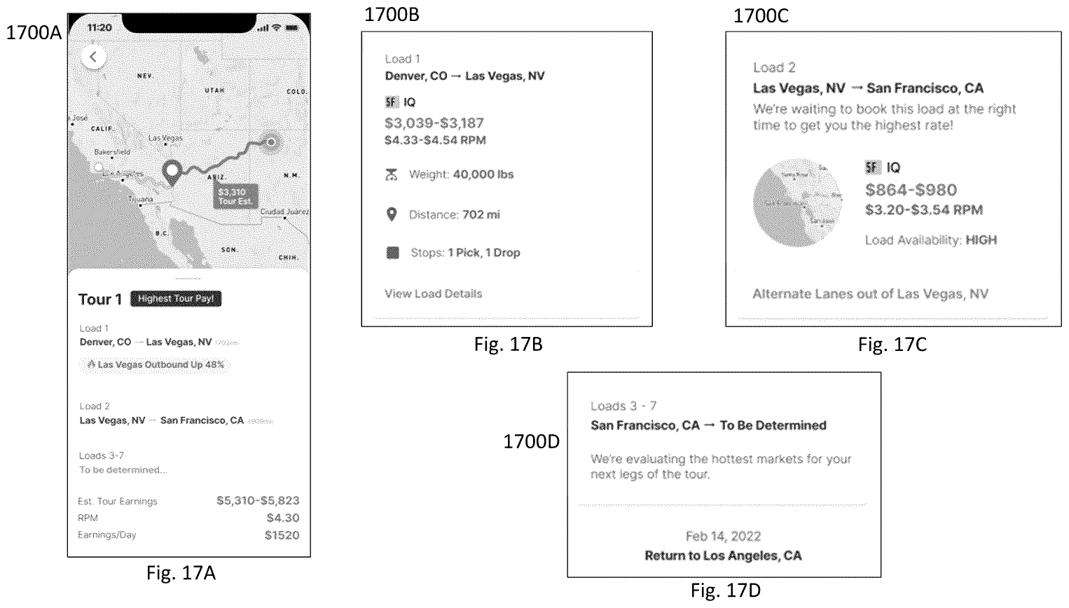

In some embodiments, when the user approves the selected simulated tours, the approved tour can be booked, for example, as illustrated in FIGS. 15 and 16. FIG. 15, for example, illustrates a user interface 1500 displaying that the user approved simulated tours are submitted for booking. FIG. 16, for example, illustrates a user interface 1600 displaying that booking of the user approved simulated tours are in progress. For example, as shown in FIG. 16, the logistics system 100 can be configured to contact and negotiate for the best rate to book the load(s) for the user. Once the load is booked and secured, the user interface shown in FIGS. 15 and 16 can be used to indicate that to the user.

In some embodiments, when the first load of the user approved simulated tour is booked, the booked tour can be displayed via user interface, for example, as illustrated in FIGS. 17A-17D. FIG. 17A for example, illustrates a user interface 1700A displaying a booked Tour 1 as including Load 1 (Denver, CO to Las Vegas, NV), Load 2 (Las Vegas, NV to San Francisco, CA), and Loads 3-7 (To be determined). FIG. 17B, for example, illustrates a user interface 1700B displaying that Load 1 (Denver, CO to Las Vegas, NV) is booked with an estimated payment of $3,039-3,187 with revenue per mile (RPM) of $4.33-$4.54 for the transportation weight of 40,000 lbs and distance of 702 mile. FIG. 17C, for example, illustrates a user interface 1700C displaying that Load 2 (Las Vegas, NV to San Francisco, CA) is waiting to be booked, for example, in order to negotiate a higher payment. FIG. 17D, for example, illustrates a user interface 1700D displaying that Load 3-7 (To be determined) is not booked, and the process is evaluating the hottest market. FIG. 17D's user interface 1700D also displays, for example, an end date of the tour as Feb. 14, 2022.

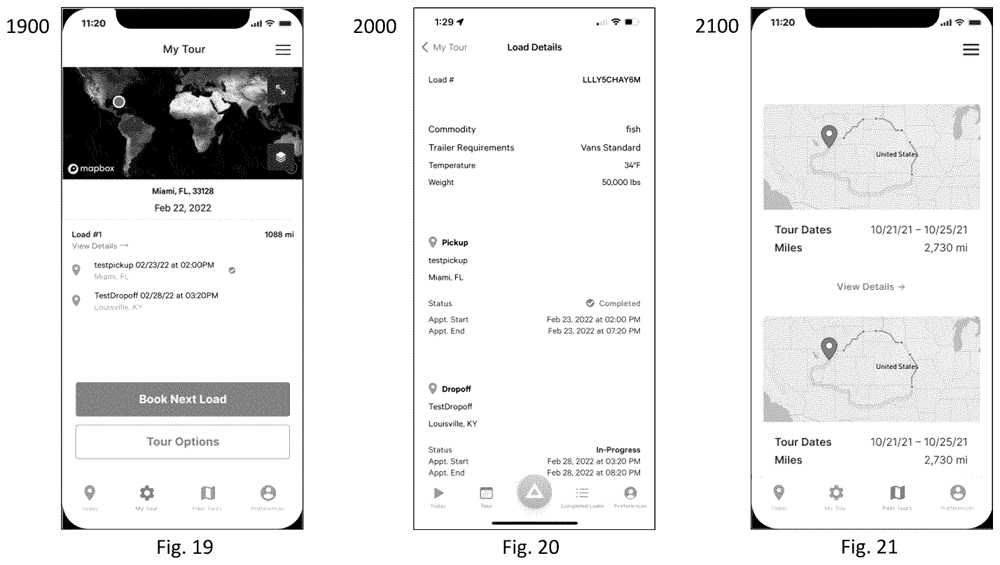

In some embodiments, detailed information of booked Tour 1's Load 1 can be displayed via user interface, for example, as illustrated in FIG. 18's user interface 1800. For example, FIG. 18's user interface 1800 shows that Load 1 from Denver, Co to Las Vegas, NV is booked with an estimated payment of $3,039-3,187 and revenue per mile (RPM) of $4.33-$4.54 for the transportation weight of 40,000 lbs and distance of 702 mile. FIG. 18's user interface 1800 also shows detailed information for the pick up and the drop off. FIG. 18's user interface 1800 also shows that there are “81 Loads Near Las Vegas, NV,” which can indicate to the user about the 81 transportation loads that are available near Las Vegas, NV.

In some embodiments, a status of a booked tour can be displayed via user interface, for example, as illustrated in FIGS. 19 and 20. For example, FIG. 19 shows a status of a booked tour with “Load #1” with “testpickup 02/23/22 at 02:00 PM” at “Miami, FL” and “testDropoff 02/28/22 at 03:20 PM” at “Louisville, KY.” FIG. 20 shows more detailed status of Load #1, for example, indicating that the commodity type is fish, tailer requirements is “Vans Standard,” temperature is 34° F., and weight is 50,000 lbs. FIG. 20 also shows that the status of pickup called “testpickup” is completed, and the status of dropoff called “TestDropoff” is in-progress. FIG. 20 also shows the time window (e.g., 5 hours) for the pickup and the dropoff as “Appt. Start” and “Appt. End” for each. In other embodiments, the time window for the pickup or the dropoff can be the same or the different, and the time window can range from 1 hour to 24 hours, or even shorter or longer depending on the types and amounts of the goods or loads being transported.

In some embodiments, the user's past tour(s) can be displayed via user interface, for example, as illustrated in FIG. 21, showing a user interface 2100 displaying “Past Tours.” For example, FIG. 21 shows a past tour from 10/21/21-10/25/21 with distance of 2,730 miles.

In some embodiments, one or more aspects of the exemplary logistics process 100 and the systems and methods described herein can be implemented with one or more computing or processing devices such as mobile devices, laptops, desktops, cloud computing resources, servers, terminals, virtualization tools, communication devices. In some embodiments, one or more such computing devices can include one or more transmitters, receivers, and/or transceivers to communicate using one or more techniques such as wired communication and/or wireless communication. In some embodiments, one or more such computing devices can comprise software such as one or more applications or apps. The steps of a process or algorithm described in connection with the embodiments described herein may be embodied directly in hardware, in a software module executed by a processor, or in a combination of the two. A software module may reside in one or more memory, such as RAM memory, flash memory, ROM memory, EPROM memory, EEPROM memory, registers, hard disk, a removable disk, a CD-ROM, or any form of computer-readable storage medium. In some embodiments, a storage medium such as memory may be coupled to the processor such that the processor can read information from, and write information to, the storage medium. In some embodiments, the storage medium may be integral to the processor.

All of the processes described herein can be embodied in, and fully automated via, software code modules executed by one or more general purpose or special purpose computers or processors. The code modules may be stored in one or more of any type of computer-readable medium or other computer storage device or collection of storage devices. Some or all of the methods may alternatively be embodied in specialized computer hardware.

All of the methods and tasks described herein may be performed and fully automated by a computer system. The computer system may, in some cases, include single or multiple distinct computers or computing devices (e.g., physical servers, workstations, storage arrays, etc.) that may communicate and interoperate over a network to perform the described functions. Each such computing device typically includes a processor (or multiple processors or circuitry or collection of circuits, e.g., a module) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A system for a transportation tour, the system comprising:
a display device;
a memory; and
a processor coupled to the memory programmed with executable instructions, the instructions including:
a data collector for automatically collecting data for the transportation tour, wherein the data collector is configured to receive a transportation load data and a market data;
a user interface configured to collect a user input, the user input comprising a user profile, a transportation tour parameter, and a current information of the user;
a data filter configured to filter the transportation load data and the market data based on the user input;
a network model engine configured to generate a network model based on the filtered transportation load data and the filtered market data, wherein the network model comprises a network of transportation loads;
a simulation engine configured to:
simulate the transportation tour based on the network model, and
automatically select a predetermined number of simulated tours based on a simulated factor; and
the user interface further configured to display the selected predetermined number of the simulated tours.

2. The system of claim 1, wherein the user profile comprises at least one of an overhead cost, a commodity type criterion, a broker criterion, a customer criterion, a region criterion, a weather criterion, a terrain criterion, a certification criterion, and a credential criterion.

3. The system of claim 1, wherein the transportation tour parameter comprises a start date of the transportation tour, a start location of the transportation tour, and transport information.

4. The system of claim 3, wherein the transportation tour parameter further comprises an end date of the transportation tour, and an end location of the transportation tour.

5. The system of claim 1, wherein the current information of the user comprises at least one of a current location of the user or a current hour of service by the user operating a transport.

6. The system of claim 1, wherein the network model engine is configured to update the network model based on:
a new transportation tour data collected by the data collector;
a new market data collected by the data collector; or
a new user input collected by the user interface.

7. The system of claim 1, wherein the network model comprises a probability model for the simulated tour.

8. The system of claim 1, wherein the simulated factor comprises at least one of a revenue of the simulated tour, an earning of the simulated tour, or an earning over distance traveled in the simulated tour.

9. The system of claim 1, wherein the transportation tour comprises a series of one or more transportation loads.

10. The system of claim 1, wherein the user interface is further configured to:
display the selected predetermined number of simulated tours for an approval by the user;
receive an approval input from the user;
book a first transportation load in the approved simulated tour; and
display a booked status of the first transportation load in the selected tour.

11. A method for a transportation tour, the method comprising:
automatically collecting a transportation load data and a market data;
collecting, via a user interface, a user input, the user input comprising a user profile, a transportation tour parameter, and a current information of the user;
filtering the transportation load data and the market data based on the user input;
generating a network model based on the filtered transportation load data and the filtered market data, wherein the network model comprises a network of transportation loads;
simulating the transportation tour based on the network model;
automatically selecting a predetermined number of simulated tours based on a simulated factor; and
displaying, via the user interface, the selected predetermined number of the simulated tours.

12. The method of claim 11, wherein the user profile comprises at least one of an overhead cost, a commodity type criterion, a broker criterion, a customer criterion, a region criterion, a weather criterion, a terrain criterion, a certification criterion, and a credential criterion.

13. The method of claim 11, wherein the transportation tour parameter comprises a start date of the transportation tour, a start location of the transportation tour, and transport information.

14. The method of claim 13, wherein the transportation tour parameter further comprises an end date of the transportation tour, and an end location of the transportation tour.

15. The method of claim 11, wherein the current information of the user comprises at least one of a current location of the user and a current hour of service by the user operating a transport.

16. The method of claim 11, further comprises updating the network model based on:
a new transportation tour data collected by the data collector;
a new market data collected by the data collector; or
a new user input collected by the user interface.

17. The method of claim 11, wherein the network model comprises a probability model for the simulated tour.

18. The method of claim 11, wherein the simulated factor comprises at least one of a revenue of the simulated tour, an earning of the simulated tour, and an earning over distance traveled in the simulated tour.

19. The method of claim 11, wherein the transportation tour comprises a series of one or more transportation loads.

20. The method of claim 11, further comprises:
displaying, via the user interface, the selected predetermined number of the simulated tours for an approval by the user;
receiving, via the user interface, an approval input from the user;
booking, via the user interface, a first transportation load in an approved simulated tour; and
displaying, via the user interface, a booked status of the first transportation load in the approved simulated tour.
